(19) United States
(12) Patent Application Publication
(10) Pub. No.: US 2021/0249815 A1
(43) Pub. Date: Aug. 12, 2021

(54) LEVER TYPE CONNECTOR

(71) Applicant: YAZAKI CORPORATION, Tokyo (JP)

(72) Inventors: Tetsuya Sekino, Makinohara-shi (JP); Hiromasa Kubota, Fujieda-shi (JP)

(21) Appl. No.: 17/155,041

(22) Filed: Jan. 21, 2021

(30) Foreign Application Priority Data
Feb. 6, 2020 (JP) 2020-019106

(51) Int. Cl. H01R 13/629; H01R 13/502

(52) U.S. Cl. CPC H01R 13/62933; H01R 13/502

(57) ABSTRACT

A lever type connector includes: a connector body including boss portions; and a lever having including a coupling portion coupling arm portions having boss fitting holes. An electric wire cover is attached to the connector body, and includes an electric wire lead-out portion. The coupling portion includes a recessed sliding portion recessed in an arc shape. In attaching the lever to the connector body, the lever is positioned relative to the connector body by bringing the recessed sliding portion in contact with a part of an outer peripheral portion of the electric wire lead-out portion of the electric wire cover so as to allow positions of the boss fitting holes to be aligned with positions of the boss portions, and the lever is rotatably attached to the connector body in a state where the boss portions are inserted into the boss fitting holes.

### CROSS-REFERENCE TO RELATED APPLICATIONS

This application is based on and claims the benefit of priority of Japanese Patent Application No. 2020-019106 filed on Feb. 6, 2020, the entire contents of which are incorporated herein by reference.

### FIELD

One or more embodiments of the present invention relate to a lever type connector.

### BACKGROUND

A lever type connector has been known, which assists fitting and detachment relative to a counterpart connector by rotating a lever rotatably provided on a connector body (see, for example, JP-A-2009-26488 and JP-A-2018-81847).

In this type of lever type connector, the lever is formed in a U-shaped cross section including a pair of arm portions and a coupling portion that couples the two arm portions. When the lever is attached to the connector body, boss portions formed on two outer side faces of the connector body are inserted into boss fitting holes formed in the two arm portions while the pair of arm portions are expanded outward by using elasticity. Therefore, the lever is rotatable.

### SUMMARY

When the lever is attached to the connector body of the above lever type connector, an operator must attach the lever to the connector body while visually aligning a position of the boss fitting hole of the lever with the boss portion of the connector body. In particular, when a coming-off prevention protrusion for locking the lever to prevent it from coming off is formed at the boss portion, an attachment angle of the lever relative to the connector body must also be visually adjusted. Therefore, it is required to improve the attachment workability of the lever to the connector body to reduce the burden on the operator.

One or more embodiments of the present invention have been made in view of the above-described circumstances, and an object thereof is to provide a lever type connector with excellent assembly workability that allows the lever to be easily positioned relative to the connector body.

In one or more embodiments of the present invention, there is provided a lever type connector including: a connector body including: a pair of side walls; and boss portions protruding from outer surfaces of the pair of side walls, respectively; and a lever having a substantially U-shape and rotatably attachable to the connector body, the lever including: a pair of arm portions having boss fitting holes into which the boss portions are inserted, respectively; and a coupling portion that couples one ends of the pair of arm portions, wherein a fitting force and a detachment force of the connector body relative to a counterpart connector is applied by rotation operation of the lever, wherein an electric wire cover is attached to the connector body, the electric wire cover being configured to cover one or more electric wires drawn out from the connector body, wherein the electric wire cover includes an electric wire lead-out portion having a tubular shape, the electric wire lead-out portion through which the one or more electric wires are allowed to be drawn out together, wherein the coupling portion includes a recessed sliding portion recessed in an arc shape, and wherein in attaching the lever to the connector body, the lever is positioned relative to the connector body by bringing the recessed sliding portion in contact with a part of an outer peripheral portion of the electric wire lead-out portion of the electric wire cover so as to allow positions of the boss fitting holes to be aligned with positions of the boss portions, and the lever is rotatably attached to the connector body in a state where the boss portions are inserted into the boss fitting holes.

One or more embodiments of the present invention can provide a lever type connector having excellent assembly workability, in which a lever can be easily positioned relative to a connector body.

The one or more embodiments of the present invention have been briefly described as above. Further, details of the present invention will be clarified by reading a mode (hereinafter, referred to as an “embodiment”) for carrying out the invention to be described below with reference to the accompanying drawings.

### BRIEF DESCRIPTION OF DRAWINGS

FIG. 1 is a side view of a lever type connector according to an embodiment of the present invention.

FIG. 2 is a side view of the lever type connector according to the present embodiment before a lever is attached thereto.

FIG. 3 is a perspective view of a connector body to which an electric wire cover is attached in advance.

FIG. 4 is a perspective view of a lever attached to the connector body.

FIGS. 5A and 5B illustrate the lever attached to the connector body, FIG. 5A is a front view of the lever, and FIG. 5B is a sectional view taken along a line IV-IV in FIG. 5A.

FIGS. 6A and 6B are side views illustrating a procedure of attaching the lever to the connector body, FIG. 6A is a side view of the lever during attachment of the lever, and FIG. 6B is a side view of the lever immediately after attachment of the lever.

FIG. 7 is a side view of a state in which a lever attached to the connector body is rotated to a temporarily locking position.

FIG. 8 is a perspective view of a counterpart connector.

### DETAILED DESCRIPTION

Hereinafter, an embodiment of the present invention will be described with reference to the drawings.

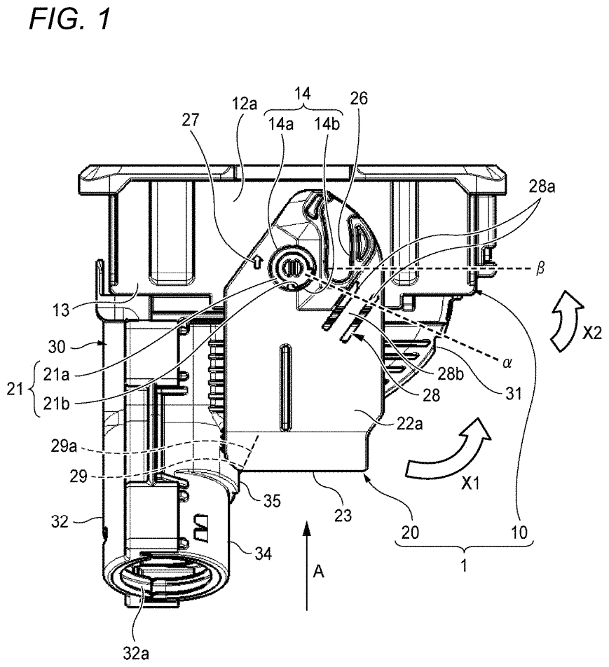

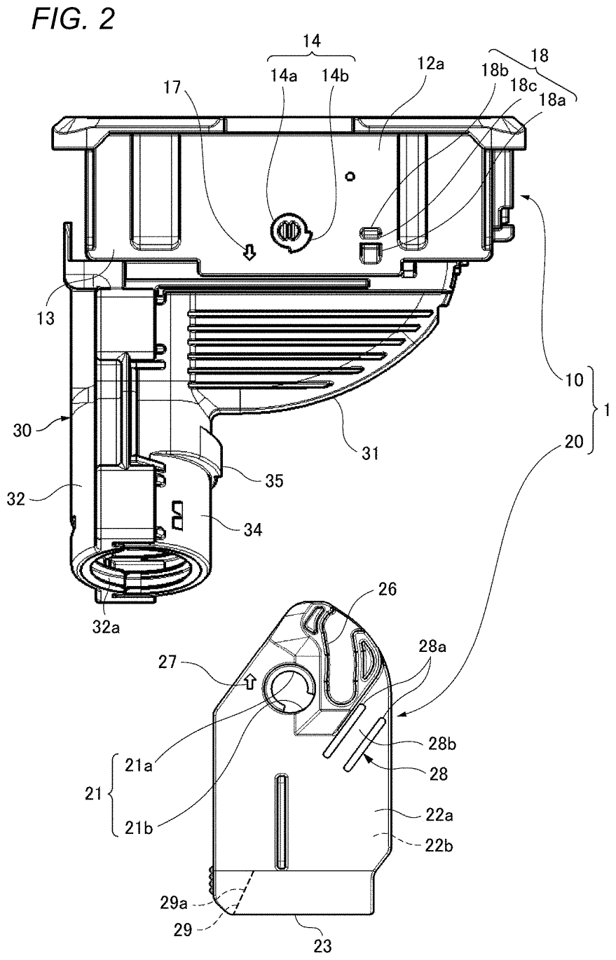

FIG. 1 is a side view of a lever type connector 1 according to an embodiment of the present invention. FIG. 2 is a side view of the lever type connector 1 according to the present embodiment before a lever 20 is attached thereto.

As illustrated in FIGS. 1 and 2, the lever type connector 1 according to the present embodiment includes a connector body 10 to be fitted and connected to a counterpart connector 2 described below, and the lever 20 to be attached to the connector body 10. An electric wire cover 30 is attached to the connector body 10 in advance. The lever 20 is attached to the connector body 10 to which the electric wire cover 30 is attached in an attachment direction A from the rear to the front.

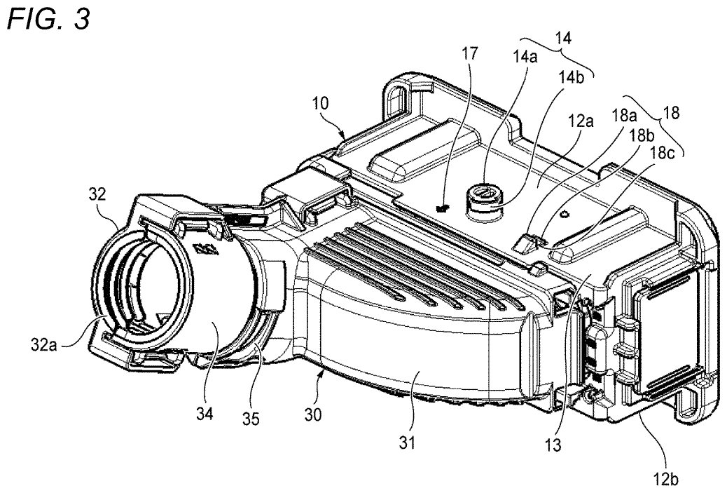

FIG. 3 is a perspective view of the connector body 10 to which the electric wire cover 30 is attached in advance.

As illustrated in FIG. 3, the connector body 10 is formed in a square tubular shape. The connector body 10 includes a terminal accommodating portion 13. A plurality of terminal fittings (not illustrated) to which terminals of an electric wire (not illustrated) are crimped and connected are accommodated and held in the terminal accommodating portion 13. The connector body 10 includes a pair of side walls 12a, 12b that are vertically disposed to face each other. A boss portion 14 for supporting the lever protrudes from an outer surface of each of the side walls 12a, 12b of the connector body 10.

The boss portion 14 is a shaft that rotatably supports the lever 20. The boss portion 14 includes a support shaft portion 14a formed in a cylindrical shape, and a coming-off prevention protrusion 14b protruding laterally from an upper end of the support shaft portion 14a.

In one side wall 12a of the connector body 10, a body-side mark (mark) 17 for visible positioning at the time of attaching the lever 20 to the connector body 10 is provided, at a position in a vicinity of the boss portion 14. The body-side mark 17 is provided in a vicinity of an edge portion on an attachment side of the lever 20 of the side wall 12a. The body-side mark 17 is formed of an “arrow” indicating a direction, and is arranged along the attachment direction A of the lever 20. The direction of the “arrow” of the body-side mark 17 is directed to the lever 20 side.

The side walls 12a, 12b of the connector body 10 each are provided with a temporarily locking protrusion 18. The temporarily locking protrusion 18 includes a pair of protruding portions 18a, 18b protruding from an outer surface of each of the side walls 12a, 12b, and a locking groove portion 18c between the protruding portions 18a, 18b.

The electric wire cover 30 is attached to a rear portion of the connector body 10, which is a side opposite to a fitting side with the counterpart connector 2. As a result, in the connector body 10, a rear portion of the terminal accommodating portion 13 is covered by the electric wire cover 30, and a plurality of electric wires (not illustrated) drawn out from the respective terminal accommodating portions 13 are protected.

The electric wire cover 30 includes a cover body 31 attached to a rear portion of the connector body 10, and a cylindrical electric wire lead-out portion 32 formed on a rear portion of the cover body 31, which is a side opposite to an attachment side to the connector body 10. The electric wire lead-out portion 32 is formed on a rear portion of the cover body 31 near an end of the electric wire cover 30 in a width direction. A plurality of electric wires (not illustrated) drawn out from the terminal accommodating portion 13 of the connector body 10 are bundled and pass through the electric wire lead-out portion 32. The electric wire lead-out portion 32 includes an electric wire lead-out port 32a which is an outlet of the electric wires.

In the connector body 10 to which the electric wire cover 30 is attached, a plurality of electric wires drawn out from the terminal accommodating portion 13 are guided to the electric wire lead-out portion 32 by the cover body 31 and are bundled, and are drawn out together from the electric wire lead-out port 32a of the electric wire lead-out portion 32.

The electric wire cover 30 attached to the connector body 10 includes a step portion 35 on the attachment side of the lever 20 to be attached to the connector body 10 in the electric wire lead-out portion 32. The step portion 35 is formed at a position in the electric wire lead-out portion 32, which is near the cover body 31. By providing the step portion 35, an inner diameter of the electric wire lead-out portion 32 of the electric wire cover 30 is increased on the cover body 31 side. The electric wire cover 30 is configured such that a plurality of electric wires drawn out from the terminal accommodating portion 13 of the connector body 10 are smoothly guided to the electric wire lead-out portion 32 through a part with an increased diameter, and drawn out from the electric wire lead-out port 32a.

In a wall surface of the electric wire lead-out portion 32 on the attachment side of the lever 20 to be attached to the connector body 10, an end portion side relative to the step portion 35 is defined as a sliding portion 34 having a smooth outer peripheral surface.

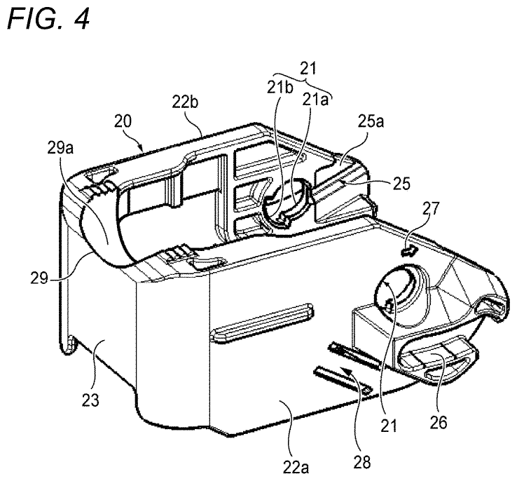

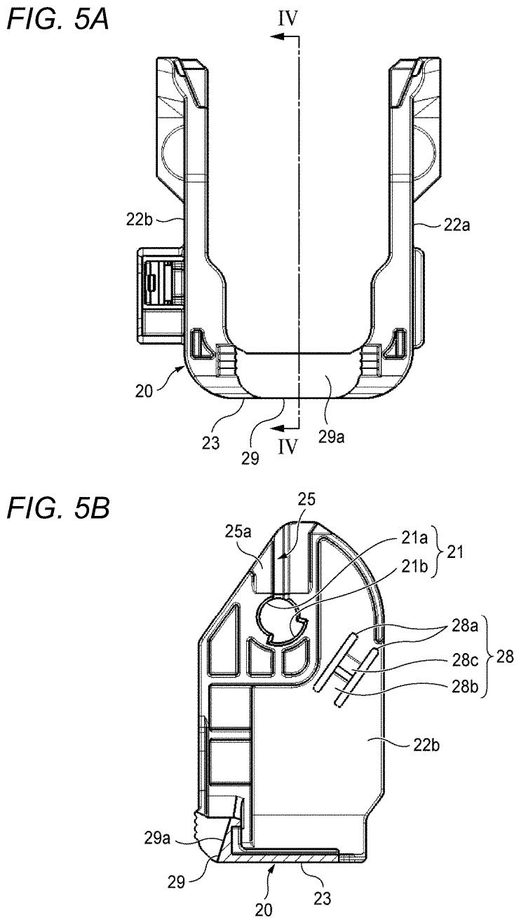

FIG. 4 is a perspective view of the lever 20 to be attached to the connector body 10. FIGS. 5A and 5B illustrate the lever 20 attached to the connector body 10, FIG. 5A is a front view of the lever 20, and FIG. 5B is a sectional view taken along a line IV-IV in FIG. 5A.

As illustrated in FIGS. 4, 5A, and 5B, the lever 20 includes a pair of arm portions 22a, 22b disposed to face each other, and a coupling portion 23 that couples one end side of the arm portion 22a to one end side of the arm portion 22b. The lever 20 is formed in a substantially U shape as a whole. The coupling portion 23 of the lever 20 serves as an operating portion, and the lever 20 is rotated relative to the connector body 10 by gripping the operating portion.

The arm portions 22a, 22b of the lever 20 are plate-shaped members that cover the pair of side walls 12a, 12b of the connector body 10, and each include a boss fitting hole 21 into which the boss portion 14 is rotatably fitted. The arm portions 22a, 22b respectively cover the outer surfaces of the pair of side walls 12a, 12b from the rear of the connector body 10, and the boss portion 14 is inserted into the boss fitting hole 21. As a result, the arm portions 22a, 22b are respectively attached to the pair of side walls 12a, 12b so as to be rotatable within a predetermined angle range around an axis of the support shaft portion 14a of the boss portion 14.

The boss fitting hole 21 includes an inner peripheral protruding ridge 21a, protruding radially inward, at an inner peripheral portion thereof. The inner peripheral protruding ridge 21a is formed along a circumferential direction except for a part of the boss fitting hole 21. In the boss fitting hole 21, a portion where the inner peripheral protruding ridge 21a is not formed is defined as a protrusion insertion portion 21b. The inner peripheral protruding ridge 21a has an inner diameter slightly larger than an outer diameter of the support shaft portion 14a of the boss portion 14, and the protrusion insertion portion 21b has an inner shape slightly larger than an outer shape of the coming-off prevention protrusion 14b of the boss portion 14.

The arm portions 22a, 22b each have a boss guiding groove 25 connected to the boss fitting hole 21 on an inner surface thereof. The boss guiding groove 25 has a width larger than an outer diameter of the boss portion 14. The boss guiding groove 25 is formed over an edge portion of each of the arm portions 22a, 22b from the boss fitting hole 21, and a bottom surface thereof is defined as a guiding surface 25a gradually inclined inward from the edge portion of each of the arm portions 22a, 22b toward the boss fitting hole 21 side.

Of the arm portions 22a, 22b of the lever 20, the arm portion 22a that covers the side wall 12a of the connector body 10 including the body-side mark 17 is provided with, on an outer surface thereof, a lever-side mark (mark) 27 for visible positioning at the time of attaching the lever 20 to the connector body 10. The lever-side mark 27 is provided in a vicinity of an edge portion of the arm portion 22a on an attachment side to the connector body 10. The lever side mark 27 is formed of an “arrow” indicating a direction, and is arranged along the attachment direction A to the connector body 10. The direction of the “arrow” of the lever-side mark 27 is directed to the connector body 10 side.

A cam groove 26, which extends from an edge portion of each of the arm portions 22a, 22b to a vicinity of the boss fitting hole 21, is provided in an outer surface of each of the arm portions 22a, 22b. One end of the cam groove 26 is open at the edge portion of each of the arm portions 22a, 22b. A cam shaft 64 described below, which is formed on the counterpart connector 2, is inserted into the cam groove 26 from the open end side.

The arm portions 22a, 22b of the lever 20 each have a temporarily locking portion 28. The temporarily locking portion 28 includes a pair of slits 28a that penetrate each of the arm portions 22a, 22b, an elastic portion 28b provided by forming the pair of slits 28a, and a locking claw portion 28c formed on the elastic portion 28b. The locking claw portions 28c are formed on inner surface sides of the arm portions 22a, 22b, which face each other. The elastic portion 28b is elastically deformable relative to the arm portions 22a, 22b in a direction perpendicular to a plane.

The lever 20 includes a recessed sliding portion 29 on the coupling portion 23. In the coupling portion 23, the recessed sliding portion 29 is formed on an electric wire lead-out portion 32 side of the electric wire cover 30 when the lever 20 is attached to the connector body 10. The recessed sliding portion 29 is formed in a recessed shape recessed in an arc shape. The sliding portion 34 of the electric wire lead-out portion 32 formed in an arc shape in a cross-sectional view may be disposed in the recessed sliding portion 29.

An inner surface of the recessed sliding portion 29 is defined as a tapered surface 29a that is gradually inclined in a direction away from the electric wire lead-out portion 32 toward the attachment direction A (see FIG. 2) to the connector body 10 to which the electric wire cover 30 is attached.

Next, a case where the lever 20 is attached to the connector body 10 to which the electric wire cover 30 is attached in advance will be described.

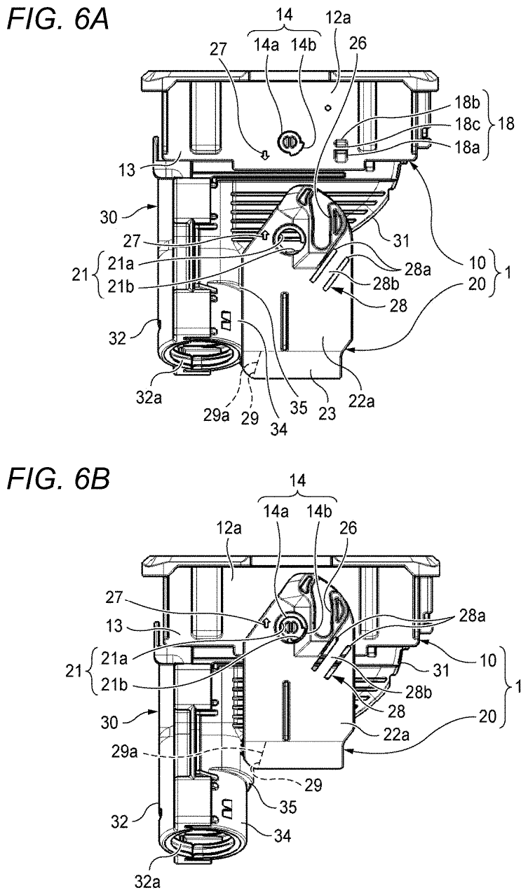

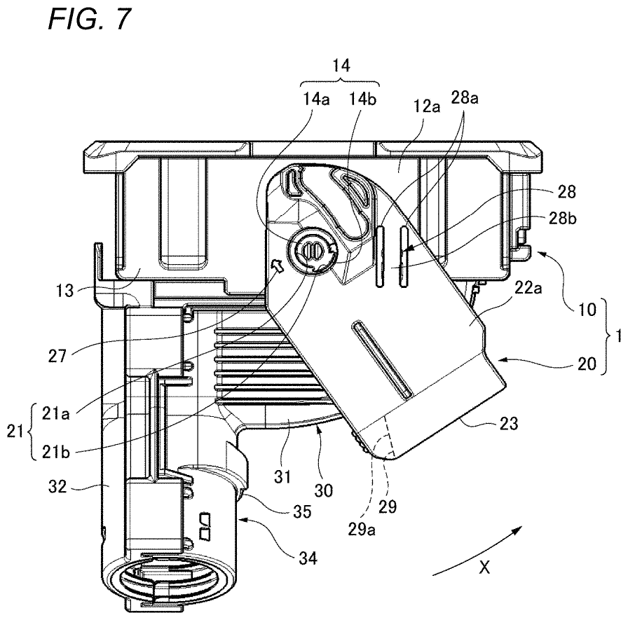

FIGS. 6A and 6B are side views illustrating a procedure of attaching the lever 20 to the connector body 10, FIG. 6A is a side view of the lever 20 during attachment thereof, and FIG. 6B is a side view of the lever 20 immediately after attachment thereof. FIG. 7 is a side view of a state in which the lever 20 attached to the connector body 10 is rotated to a temporarily locking position.

First, as illustrated in FIG. 6A, positions and directions of the body-side mark 17 of the connector body 10 to which the electric wire cover 30 is attached and the lever-side mark 27 of the lever 20 are checked. Then, the lever 20 is brought close to the connector body 10 while causing the direction indicated by the “arrow” of the body-side mark 17 to face the direction indicated by the “arrow” of the lever-side mark 27.

The recessed sliding portion 29 formed on the coupling portion 23 of the lever 20 is positioned relative to the sliding portion 34, which is a part of an outer peripheral portion of the electric wire lead-out portion 32 of the electric wire cover 30, while being brought close to the sliding portion 34. Then, the sliding portion 34 of the electric wire lead-out portion 32 of the electric wire cover 30 enters the recessed sliding portion 29 of the lever 20, and the lever 20 is positioned relative to the connector body 10. As a result, a position of the lever 20 relative to the connector body 10 in a direction perpendicular to the attachment direction A and an attachment angle of the lever 20 relative to the connector body 10 are adjusted.

Next, as illustrated in FIG. 6B, the lever 20 is brought close to the connector body 10 in a direction indicated by the lever-side mark 27. Then, the boss portion 14 of the connector body 10 enters the edge portion of the boss guiding groove 25 of the lever 20 and abuts against the guiding surface 25a. In this state, the lever 20 is pushed against the connector body 10. Then, the boss portion 14 is guided in the boss guiding groove 25 while being in sliding contact with the guiding surface 25a, and is moved relatively along the boss guiding groove 25, whereby the arm portions 22a, 22b are pushed outward and elastically deformed.

At this time, the recessed sliding portion 29 of the lever 20 is slid relative to the sliding portion 34 of the electric wire lead-out portion 32 of the electric wire cover 30 that has entered the recessed sliding portion 29. As a result, the position of the lever 20 relative to the connector body 10 in a direction perpendicular to the attachment direction A and the attachment angle of the lever 20 relative to the connector body 10 are maintained.

When the recessed sliding portion 29 reaches the step portion 35 of the electric wire lead-out portion 32, the step portion 35 abuts against the tapered surface 29a of the recessed sliding portion 29 and slides. As a result, the coupling portion 23 is not caught by the step portion 35 of the electric wire lead-out portion 32, and thus, the lever 20 is smoothly and relatively moved toward the connector body 10.

Thereafter, the boss portion 14 reaches the boss fitting hole 21 of each of the arm portions 22a, 22b of the lever 20. In this case, the lever 20 is moved relatively toward the connector body 10 after the lever 20 is positioned relative to the connector body 10 according to the body-side mark 17 and the lever-side mark 27, so that the coming-off prevention protrusion 14b of the boss portion 14 is easily matched with the protrusion insertion portion 21b of the boss fitting hole 21 in a plan view. Therefore, when the boss portion 14 reaches the boss fitting hole 21, the elastically deformed arm portions 22a, 22b are restored, and the boss portion 14 including the support shaft portion 14a and the coming-off prevention protrusion 14b is inserted into the boss fitting hole 21 including the inner peripheral protruding ridge 21a and the protrusion insertion portion 21b. The coming-off prevention protrusion 14b of the boss portion 14 is disposed outside the inner peripheral protruding ridge 21a of the boss fitting hole 21. As a result, the lever 20 is rotatably attached to the connector body 10 to which the electric wire cover 30 is attached.

When the boss portion 14 is inserted into the boss fitting hole 21, the lever 20 is rotated relative to the connector body 10 in one direction (a direction of an arrow X1) as illustrated in FIG. 7, and the open end of the cam groove 26 is disposed at a temporarily locking position α directed to the fitting side with the counterpart connector 2 (see FIG. 1). Then, the coming-off prevention protrusion 14b formed on the boss portion 14 of each of the arm portions 22a, 22b moves to an outside of the inner peripheral protruding ridge 21a of the boss fitting hole 21, and is locked to the inner peripheral protruding ridge 21a. As a result, the lever 20 is maintained in an attachment state relative to the connector body 10, and detachment of the lever 20 from the connector body 10 due to the application of an external force or the like is prevented.

When the lever 20 is rotated to be disposed at the temporarily locking position α, the locking claw portion 28c provided on the elastic portion 28b of the temporarily locking portion 28 of each of the arm portions 22a, 22b of the lever 20 enters the locking groove portion 18c of the temporarily locking protrusion 18 formed on each of the side walls 12a, 12b of the connector body 10. As a result, the lever 20 is maintained in a state of being disposed at the temporarily locking position α when the locking claw portion 28c is locked to the locking groove portion 18c. The lever type connector 1 is fitted to the counterpart connector 2 in a state in which the lever 20 is disposed at the temporarily locking position α.

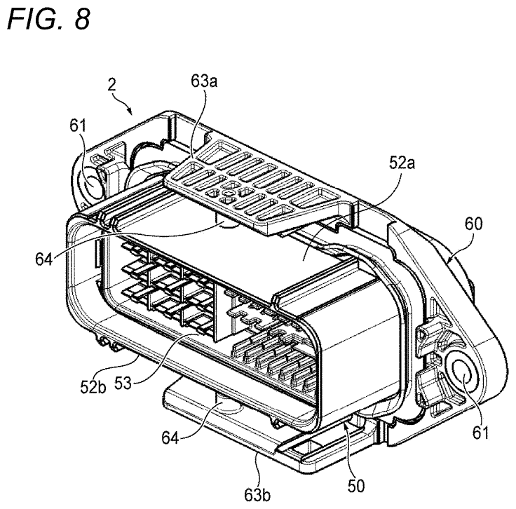

FIG. 8 is a perspective view of the counterpart connector 2.

As illustrated in FIG. 8, the counterpart connector 2 to which the lever type connector 1 according to the present embodiment is to be fitted includes a connector body 50 and a flange portion 60. The connector body 50 is formed in a square tubular shape having a smaller outer shape than that of the connector body 10 of the lever type connector 1, and includes a terminal accommodating portion 53, which accommodates a plurality of terminal fittings, therein.

A bolt insertion hole 61 is formed in the flange portion 60, and a bolt (not illustrated) inserted into the bolt insertion hole 61 is screwed into a screw hole formed in an attachment portion (not illustrated) such as a housing, and thereby the counterpart connector 2 is fixed to the attachment portion.

A pair of wall portions 63a, 63b are formed in the flange portion 60. The wall portion 63a, 63b are respectively disposed with gaps between the wall portions 63a, 63b and a pair of side walls 52a, 52b of the connector body 50. Cam shafts 64 protruding toward the side walls 52a, 52b are respectively formed on the wall portions 63a, 63b.

In order to fit the lever type connector 1 to the counterpart connector 2, the connector body 50 of the counterpart connector 2 is fitted into the connector body 10 in a state in which the lever 20 is disposed at the temporarily locking position α. Then, the cam shaft 64 provided on the counterpart connector 2 is inserted into the cam groove 26 from one end side. In this state, the lever 20 is rotated in one direction (a direction of an arrow X2 in FIG. 1), and the lever 20 is disposed at the final locking position β along the connector body 10 (see FIG. 1). Then, the cam shaft 64 inserted into one end of the cam groove 26 is relatively guided to the other end of the cam groove 26 that reaches the vicinity of the boss fitting hole 21. As a result, the counterpart connector 2 is pulled and fitted to the connector body 10, and the terminal fittings of the respective terminal accommodating portions 13, 53 are electrically connected to each other.

In this fitting state, when the lever 20 is rotated in the other direction (a direction opposite to the direction of the arrow X2 in FIG. 1) to be disposed at the temporarily locking position α, the cam shaft 64 of the counterpart connector 2 pulled into the other end side of the cam groove 26 is pushed out to one end side of the cam groove 26. As a result, the connector body 50 of the counterpart connector 2 is pushed out and detached from the connector body 10 of the lever type connector 1, and the electrical connection state between the terminal fittings of the respective terminal accommodating portions 13, 53 is released.

As described above, according to the lever type connector 1 of the present embodiment, an operator attaches the lever 20 to the connector body 10 by positioning the recessed sliding portion 29 of the lever 20 relative to the sliding portion 34, which is a part of the outer peripheral portion of the electric wire lead-out portion 32 of the electric wire cover 30, while bringing the recessed sliding portion 29 close to the sliding portion 34. Then, the recessed sliding portion 29 is slid on the electric wire lead-out portion 32, and the lever 20 is guided to the connector body 10. As a result, the position of the boss fitting hole 21 of the lever 20 is aligned with the position of the boss portion 14 of the connector body 10, and the boss portion 14 is inserted into the boss fitting hole 21, so that the lever 20 can be rotatably attached to the connector body 10. Therefore, the lever 20 can be easily attached to the connector body 10 by being positioned relative to the connector body 10 without using a positioning jig or the like. Accordingly, the attaching workability of the lever 20 relative to the connector body 10 can be improved, and the burden on the operator can be reduced.

The inner surface of the recessed sliding portion 29 is defined as the tapered surface 29a that is gradually inclined in a direction away from the electric wire lead-out portion 32 toward the attachment direction A of the lever 20 to the connector body 10. Therefore, even if a protruding portion such as the step portion 35 is provided on the outer peripheral portion of the electric wire lead-out portion 32 of the electric wire cover 30, the protruding portion such as the step portion 35 abuts against the tapered surface 29a of the recessed sliding portion 29 and slides when the lever 20 is attached to the connector body 10. Therefore, the protruding portion of the electric wire lead-out portion 32 is not caught by the coupling portion 23 of the lever 20, and thus, the lever 20 can be smoothly and relatively moved toward the connector body 10 and attached to the connector body 10.

Further, the operator can check a positioning state of the lever 20 relative to the connector body 10 and the attachment direction of the lever 20 to the connector body 10 by visually confirming that the direction indicated by the arrow of the body-side mark 17 of the connector body 10 faces the direction indicated by the arrow of the lever-side mark 27 of the lever 20. As a result, the attachment workability of the lever 20 relative to the connector body 10 can be further improved, and the burden on the operator can be reduced.

The present invention is not limited to the above embodiment, and modifications, improvements, and the like can be made as appropriate. In addition, materials, shapes, dimensions, numbers, arrangement positions or the like of elements in the embodiment described above are optional and not limited as long as the present invention can be achieved.

Here, features of the lever type connector according to the embodiment of the present invention described above are briefly summarized in the following [1] to [3].

[1] A lever type connector (1) including:

a connector body (10) including:
a pair of side walls (12a, 12b); and
boss portions (14) protruding from outer surfaces of the pair of side walls (12a, 12b), respectively; and

a lever (20) having a substantially U-shape and rotatably attachable to the connector body (10), the lever (20) including:
a pair of arm portions (22a, 22b) having boss fitting holes (21) into which the boss portions (14) are inserted, respectively, and
a coupling portion (23) that couples one ends of the pair of arm portions (22a, 22b),

wherein a fitting force and a detachment force of the connector body (10) relative to a counterpart connector (2) is applied by rotation operation of the lever (20),

wherein an electric wire cover (30) is attached to the connector body (10), the electric wire cover (30) being configured to cover one or more electric wires drawn out from the connector body (10),

wherein the electric wire cover (30) includes an electric wire lead-out portion (32) having a tubular shape, the electric wire lead-out portion (32) through which the one or more electric wires are allowed to be drawn out together,

wherein the coupling portion (23) includes a recessed sliding portion (29) recessed in an arc shape, and

wherein in attaching the lever (20) to the connector body (10), the lever (20) is positioned relative to the connector body (10) by bringing the recessed sliding portion (29) in contact with a part of an outer peripheral portion of the electric wire lead-out portion (32) of the electric wire cover (30) so as to allow positions of the boss fitting holes (21) to be aligned with positions of the boss portions (14), and the lever (20) is rotatably attached to the connector body (10) in a state where the boss portions (14) are inserted into the boss fitting holes (21).

[2] The lever type connector (1) according to the above [1],

wherein an inner surface of the recessed sliding portion (29) includes a tapered surface (29a) that is gradually inclined in a direction away from the electric wire lead-out portion (32) toward an attachment direction (A) of the lever (20) to the connector body (10).

[3] The lever type connector (1) according to the above [1] or [2],

wherein eachc of the connector body (10) and the lever (20) is provided with a mark (a body-side mark 17, a lever-side mark 27) for positioning that is formed of an arrow indicating an attachment direction, and

wherein when the lever (20) is positioned relative to the connector body (10) by bringing the recessed sliding portion (29) in contact with the part of the outer peripheral portion of the electric wire lead-out portion (32), a direction indicated by the arrow of the mark (the lever-side mark 27) provided on the lever (20) is opposite to a direction indicated by the arrow of the mark (the body-side mark 17) provided on the connector body (10).

According to the lever type connector having the configuration of the above [1], an operator attaches the lever to the connector body by positioning the lever relative to the connector body while bringing the recessed sliding portion in contact with the part of the outer peripheral portion of the electric wire lead out portion of the electric wire cover. Then, the recessed sliding portion is slid on the electric wire lead-out portion, and the lever is guided to the connector body. As a result, the positions of the boss fitting holes of the lever are aligned with the positions of the boss portions of the connector body, and the boss portions are inserted into the boss fitting holes, so that the lever can be rotatably attached to the connector body. Therefore, the lever can be easily attached to the connector body by being positioned relative to the connector body without using a positioning jig or the like. Accordingly, the attachment workability of the lever relative to the connector body can be improved, and the burden on the operator can be reduced.

According to the lever type connector having the configuration of the above [2], even if a protruding portion such as a step portion or a protrusion is provided on the outer peripheral portion of the electric wire lead-out portion of the electric wire cover, the protruding portion abuts against the tapered surface of the recessed sliding portion and slides when the lever is attached to the connector body. Therefore, the protruding portion of the electric wire lead-out portion is not caught by the coupling portion of the lever, and thus, the lever can be smoothly and relatively moved toward the connector body and attached to the connector body.

According to the lever type connector having the configuration of the above [3], the operator can check a positioning state of the lever relative to the connector body and an attachment direction of the lever to the connector body by visually confirming that the directions indicated by the arrows of the marks for positioning of the connector body and the lever are opposed to each other. As a result, the attachment workability of the lever relative to the connector body can be further improved, and the burden on the operator can be reduced.

1. A lever type connector comprising:
a connector body comprising:
a pair of side walls; and
boss portions protruding from outer surfaces of the pair of side walls, respectively; and
a lever having a substantially U-shape and rotatably attachable to the connector body, the lever comprising:
a pair of arm portions having boss fitting holes into which the boss portions are inserted, respectively; and
a coupling portion that couples one ends of the pair of arm portions,
wherein a fitting force and a detachment force of the connector body relative to a counterpart connector is applied by rotation operation of the lever,
wherein an electric wire cover is attached to the connector body, the electric wire cover being configured to cover one or more electric wires drawn out from the connector body,
wherein the electric wire cover comprises an electric wire lead-out portion having a tubular shape, the electric wire lead-out portion through which the one or more electric wires are allowed to be drawn out together,
wherein the coupling portion comprises a recessed sliding portion recessed in an arc shape, and
wherein in attaching the lever to the connector body, the lever is positioned relative to the connector body by bringing the recessed sliding portion in contact with a part of an outer peripheral portion of the electric wire lead-out portion of the electric wire cover so as to allow positions of the boss fitting holes to be aligned with positions of the boss portions, and the lever is rotatably attached to the connector body in a state where the boss portions are inserted into the boss fitting holes.

2. The lever type connector according to claim 1,
wherein an inner surface of the recessed sliding portion comprises a tapered surface that is gradually inclined in a direction away from the electric wire lead-out portion toward an attachment direction of the lever to the connector body.

3. The lever type connector according to claim 1,
wherein each of the connector body and the lever is provided with a mark for positioning that is formed of an arrow indicating an attachment direction, and
wherein when the lever is positioned relative to the connector body by bringing the recessed sliding portion in contact with the part of the outer peripheral portion of the electric wire lead-out portion, a direction indicated by the arrow of the mark provided on the lever is opposite to a direction indicated by the arrow of the mark provided on the connector body.
